(19) United States
(12) Patent Application Publication
(10) Pub. No.: US 2014/0083537 A1
(43) Pub. Date: Mar. 27, 2014

(54) Y-Channel and Method for Production Thereof

(71) Applicant: Stefan Wendland, Frankfurt am Main (DE)

(72) Inventor: Stefan Wendland, Frankfurt am Main (DE)

(73) Assignee: SANOFI-AVENTIS DEUTSCHLAND GMBH, Frankfurt am Main (DE)

(21) Appl. No.: 14/115,343

(22) PCT Filed: May 4, 2012
(86) PCT No.: PCT/EP2012/058262

§ 371 Date: Nov. 2, 2013

(30) Foreign Application Priority Data
May 6, 2011 (EP) 11165123.8

(51) Int. Cl. F16L 41/02; B29C 45/03

(52) U.S. Cl. CPC F16L 41/023; B29C 45/03
USPC 137/602; 264/328.1

(57) ABSTRACT

The technical problem of providing a channel, which is more reliable, prevents contamination of guided liquids and which can be produced in an easy and cost saving way, is solved by an apparatus, comprising a plastic part, a channel within said plastic part configured to guide at least one fluid, wherein said channel is configured to be used in a medical device, wherein said channel is a y-channel having three ends and wherein said channel is produced with gas injection technique and/or water injection technique. The technical problem is further solved by a method to produce at least a part of a medical device, comprising the steps of producing a y-channel within a plastic part with gas injection technique and/or water injection technique and opening said y-channel to produce at least one opening.

### CROSS REFERENCE TO RELATED APPLICATIONS

The present application is a U.S. National Phase application pursuant to 35 U.S.C. §371 of International Application No. PCT/EP2012/058262 filed May 4, 2012, which claims priority to European Patent Application No. 11165123.8 filed May 6, 2011. The entire disclosure contents of these applications are herewith incorporated by reference into the present application.

### FIELD OF INVENTION

The present patent application relates to medical devices of delivering at least two drug agents from separate reservoirs. Such drug agents may comprise a first and a second medicament. The medical device includes a dose setting mechanism for delivering the drug automatically or manually by the user.

### BACKGROUND

The drug agents may be contained in two or more multiple dose reservoirs, containers or packages, each containing independent (single drug compound) or pre-mixed (co-formulated multiple drug compounds) drug agents.

Certain disease states require treatment using one or more different medicaments. Some drug compounds need to be delivered in a specific relationship with each other in order to deliver the optimum therapeutic dose. The present patent application is of particular benefit where combination therapy is desirable, but not possible in a single formulation for reasons such as, but not limited to, stability, compromised therapeutic performance and toxicology.

For example, in some cases it might be beneficial to treat a diabetic with a long acting insulin (also may be referred to as the first or primary medicament) along with a glucagon-like peptide-1 such as GLP-1 or GLP-1 analog (also may be referred to as the second drug or secondary medicament).

### SUMMARY

Accordingly, there exists a need to provide devices for the delivery of two or more medicaments in a single injection or delivery step that is simple for the user to perform without complicated physical manipulations of the drug delivery device. The proposed drug delivery device provides separate storage containers or cartridge retainers for two or more active drug agents. These active drug agents are then only combined and/or delivered to the patient during a single delivery procedure. These active agents may be administered together in a combined dose or alternatively, these active agents may be combined in a sequential manner, one after the other.

The drug delivery device also allows for the opportunity of varying the quantity of the medicaments. For example, one fluid quantity can be varied by changing the properties of the injection device (e.g., setting a user variable dose or changing the device's “fixed” dose). The second medicament quantity can be changed by manufacturing a variety of secondary drug containing packages with each variant containing a different volume and/or concentration of the second active agent.

The drug delivery device may have a single dispense interface. This interface may be configured for fluid communication with the primary reservoir and with a secondary reservoir of medicament containing at least one drug agent. The drug dispense interface can be a type of outlet that allows the two or more medicaments to exit the system and be delivered to the patient.

The combination of compounds as discrete units or as a mixed unit can be delivered to the body via a double-ended needle assembly. This would provide a combination drug injection system that, from a user's perspective, would be achieved in a manner that closely matches the currently available injection devices that use standard needle assemblies. One possible delivery procedure may involve the following steps:

1. Attach a dispense interface to a distal end of the electro-mechanical injection device. The dispense interface comprises a first and a second proximal needle. The first and second needles pierce a first reservoir containing a primary compound and a second reservoir containing a secondary compound, respectively.

2. Attach a dose dispenser, such as a double-ended needle assembly, to a distal end of the dispense interface. In this manner, a proximal end of the needle assembly is in fluidic communication with both the primary compound and secondary compound.

3. Dial up/set a desired dose of the primary compound from the injection device, for example, via a graphical user interface (GUI).

4. After the user sets the dose of the primary compound, the micro-processor controlled control unit may determine or compute a dose of the secondary compound and preferably may determine or compute this second dose based on a previously stored therapeutic dose profile. It is this computed combination of medicaments that will then be injected by the user. The therapeutic dose profile may be user selectable.

5. Optionally, after the second dose has been computed, the device may be placed in an armed condition. In such an optional armed condition, this may be achieved by pressing and/or holding an “OK” button on a control panel. This condition may provide for greater than a predefined period of time before the device can be used to dispense the combined dose.

6. Then, the user will insert or apply the distal end of the dose dispenser (e.g., a double ended needle assembly) into the desired injection site. The dose of the combination of the primary compound and the secondary compound (and potentially a third medicament) is administered by activating an injection user interface (e.g., an injection button).

Both medicaments may be delivered via one injection needle or dose dispenser and in one injection step. This offers a convenient benefit to the user in terms of reduced user steps compared to administering two separate injections.

In any case, it is very advantageous, if there is a channel, which guides and combines the liquids of the at least two medicaments, so that the medicaments only need to be ejected via a single injection needle.

In the state of the art, this guide is produced for example from at least two, often more, single parts which need to be fixed together. The problem of such techniques is that it can result in issues like bad connections due to improperly fixed parts. This can then result in leakages of the guided liquids and/or even a blockage of the channel due to small parts being caught in the channel. Those small parts might, for example, result from microwave welding in order to fix the parts together.

Moreover, in order to tightly fix the parts together, which are building the channel, adhesives in form of glue might be used. This results in the constant risk of such chemicals finding their way into the guided liquid medicaments with possibly causing side effects for the user.

Since the channels are small, it is not possible to produce such channels with standard injection molding techniques.

The invention faces the technical problem of providing a channel, which is more reliable, prevents contamination of guided liquids and which can be produced in an easy and cost saving way.

The technical problem is solved by an apparatus, comprising a plastic part, a channel within said plastic part configured to guide at least one fluid, wherein said channel is configured to be used in a medical device, wherein said channel is a y-channel having three ends and wherein said channel is produced with gas injection technique and/or water injection technique.

By using the gas injection technique (GIT) or water injection technique (WIT), the y-channel can be produced in a substantially one part design. The y-channel is provided in a single plastic part, without having to produce the plastic part from further single parts. Thus the aforementioned disadvantages are avoided, since no parts need to be fixed together to build the inner surface of the y-channel being able to guide a liquid. Moreover by using the GIT/WIT saves assembly steps and the y-channel is thus easier and more efficient to produce.

It is especially advantageous that by using GIT/WIT no chemical changes of the plastic takes place. Hence no chemical reactions between the plastic and the liquids like medicaments can occur.

A y-channel is understood to be any channel having three ends. Thus a T-piece, for example, would also be a y-channel in this sense. Preferably, a y-channel has two substantially identical channel arms, having an angle of less then 180° between them, and a third arm at the intersection of the two first arms, while the third arm extends away from the angle being less than 180°. It is preferred if the axis of the third arm substantially cuts the angle between the first arms in half. This way the guide of the liquid from the first and second arm into the third arm is supported with the y-channel in an upright (third arm facing down) position. Though an asymmetrical shape with the third arm not cutting the angle between the first arms in half is also possible.

GIT is a technique, where a molten material, for example molten plastic, is injected into a substantially closed mold, which is then partially filled with the molten material. Right before or after the end of this partial filling process a gas injection into the molten material is started. While the outer parts of the molten material already start to cool down and solidify, the gas is pushing aside the molten core of the material and pushing the material against the inner walls of the mold thus creating a piece having an outer shape substantially determined by the inner shape of the mold and at the same time an inner cavity produced by the gas injection. The pressure of the gas may also be maintained for a certain time even after the molten material with its inner gas core already fills out the whole mold, in order to allow the material to cool down without deforming again. Hence, this technique is also referred to as internal gas pressure injection moulding.

The same technique may also be performed with water instead of gas, leading to the technique called WIT or internal water pressure injection moulding.

By utilizing GIT/WIT for the production of a y-channel, which can be implemented in a medical device, the y-channel can be implemented in the one piece plastic part without any needs for assembling.

The plastic part has preferably substantially the form of the y-channel. Since the form of the inner cavity produced by GIT/WIT strongly depends on the form of the mold, the mold and thus the outer form of the plastic part preferably also have the form of the y-channel. By providing a plastic part substantially in the form the y-channel, the production of the y-channel inside the plastic part is facilitated.

Preferably said y-channel has an opening at all three ends. This is in particular advantageous if two liquids shall be guided through the y-channel and the two liquids shall be ejected from the y-channel via a common opening. The first and second arm of the y-channel can be used for one liquid each and the third arm can be used as the common opening.

The opening can be achieved by opening the ends by mechanical means, such as mechanical cutting or drilling, or by laser cutting, for example. Preferably at least one of said openings is produced by cutting said y-channel, because this results in a clean opening, and the cutting can be easily implemented in the production process.

According to another embodiment said y-channel has a substantially constant diameter. A constant diameter means that every arm of the y-channel has substantially the same diameter. This way the production is further facilitated and the y-channel can easily be produced by GIT/WIT.

It is further advantageous, if only the first and the second arm of the y-channel have substantially the same diameter and the third arm has a larger diameter. This optimises the fluidic flow of the liquids inside the y-channel, since the two liquids guided by the first and second arm of the y-channel combine in the third arm.

Preferably said y-channel has a diameter between 0.08 and 3 mm, in particular preferably smaller than 2 mm, especially preferably smaller than 1 mm. This does not necessarily mean that the whole y-channel has a single diameter, but that the diameter may also vary in the given range. Those diameters match those of standard needles used for medical purposes. This further optimises the fluidic flow of the liquids and reduces the dead volume inside the y-channel. By utilizing GIT/WIT y-channels with such diameters are producible more easily and economically in a one part design.

According to a further embodiment said y-channel is substantially axially symmetrical. The symmetry axis is preferably the axis of the third arm of the y-channel. On the one hand this further facilitates the production process, since too complex or asymmetric geometries might render the GIT/WIT production more unreliable. On the other hand the symmetry supports an equal mixing of two liquids being guided by the first and second arm of the y-channel and combining in the third arm.

According to another embodiment the apparatus further comprises an inner body and/or a main outer body. The plastic part with the y-channel by this means can be easily implemented into or connected to further devices. In particular the plastic part may be implemented in the inner body. The inner body may comprise a two part design in between those two parts the plastic part can be implemented and the two parts of the inner body can be fixed by common means such as form fit, force fit or material bonding. This inner body then can be implemented in the same manner into a main outer body, for example of a medical device. Though, the plastic part can also be directly implemented into a main outer body. The inner body or the main outer body may comprise further elements, such as piercing needles, valve seals and/or a septum. In particular one piercing needle for the first and second arm of the y-channel is provided and a septum to seal the opening of the third arm of the y-channel.

Preferably said apparatus is a dispense interface. The dispense interface is in particular attachable to a cartridge holder on the one side and a dose dispenser on the other side. The main outer body can provide means for attaching the dispense interface to a cartridge holder as well as means for attaching the dispense interface to a dose dispenser.

The technical problem is further solved by a method to produce at least a part of a medical device, comprising the steps of producing a y-channel within a plastic part with gas injection technique and/or water injection technique and opening said y-channel to produce at least one opening.

By using the gas injection technique (GIT) or water injection technique (WIT), the y-channel can be produced in a substantially one part design. The y-channel is provided in a single plastic part, without having to produce the plastic part from further single parts. Thus the disadvantages known from the state of the art are avoided, since no parts need to be fixed together to build the inner surface of the y-channel being able to guide a liquid. Moreover by using the GIT/WIT saves assembly steps and the y-channel is thus easier and more efficient to produce.

As described above, a molten material and a gas or water injection is used to create the y-channel within the plastic part. Generally the injection sites of the molten plastic and the gas can be independently positioned from each other. The gas injection can take place over the same injection site as the molten plastic for example. It is preferred though, that the gas injection site is different from the molten plastic injection site. This reduces the complexity of the tools needed. There might as well be multiple injection sites for gas.

The same applies to WIT. The use of gas is preferred though, because he implementation of water into the production process is more complex than that of gas and with GIT the parts simply do not become wet.

In a preferred embodiment all three ends of said y-channel are opened. As described above, the opening can be achieved by opening the ends by mechanical means, such as mechanical cutting or drilling, or by laser cutting, for example. Preferably at least one of said openings is produced by cutting said y-channel, because this results in a clean opening, and the cutting can be easily implemented in the production process.

Preferably said plastic part is further implemented into an inner body. The inner body may comprise a two part design in between those two parts the plastic part can be implemented and the two parts of the inner body can be fixed by common means such as form fit, force fit or material bonding. The plastic part with the y-channel by this means can be easily implemented into or connected to further devices. This inner body then can be implemented in the same manner into a main outer body, for example of a medical device.

It is preferred when said plastic part is further implemented into a main outer body of a dispense interface. The main outer body may comprise further elements, such as piercing needles, valve seals and/or a septum. In particular one piercing needle for the first and second arm of the y-channel is provided and a septum to seal the opening of the third arm of the y-channel. The dispense interface is in particular attachable to a cartridge holder on the one side and a dose dispenser on the other side. The main outer body can provide means for attaching the dispense interface to a cartridge holder as well as means for attaching the dispense interface to a dose dispenser.

According to a further embodiment said y-channel has a diameter between 0.08 and 3 mm, in particular preferably smaller than 2 mm, especially preferably smaller than 1 mm. This does not necessarily mean that the whole y-channel has a single diameter, but that the diameter may also vary in the given range. Those diameters match those of standard needles used for medical purposes. This further optimises the fluidic flow of the liquids inside the y-channel. By utilizing GIT/WIT y-channels with such diameters are producible more easily and economically in a one part design.

### BRIEF DESCRIPTION OF THE DRAWINGS

These as well as other advantages of various aspects of the present invention will become apparent to those of ordinary skill in the art by reading the following detailed description, with appropriate reference to the accompanying drawings, in which:

FIG. 1 illustrates a perspective view of the delivery device illustrated in FIGS. 1a and 1b with an end cap of the device removed;

FIG. 2 illustrates a perspective view of the delivery device distal end showing the cartridge;

FIG. 3 illustrates a perspective view of the cartridge holder illustrated in FIG. 1 with one cartridge retainer in an open position;

FIG. 4 illustrates a dispense interface and a dose dispenser that may be removably mounted on a distal end of the delivery device illustrated in FIG. 1;

FIG. 5 illustrates the dispense interface and the dose dispenser illustrated in FIG. 4 mounted on a distal end of the delivery device illustrated in FIG. 1;

FIG. 6 illustrates one arrangement of the dose dispenser that may be mounted on a distal end of the delivery device;

FIG. 7 illustrates a perspective view of the dispense interface illustrated in FIG. 4;

FIG. 8 illustrates another perspective view of the dispense interface illustrated in FIG. 4;

FIG. 9 illustrates a cross-sectional view of the dispense interface illustrated in FIG. 4;

FIG. 10 illustrates an exploded view of the dispense interface illustrated in FIG. 4;

FIG. 11 illustrates a cross-sectional view of the dispense interface and dose dispenser mounted onto a drug delivery device, such as the device illustrated in FIG. 1;

FIG. 12a-d illustrate the production of a y-channel with GIT/WIT;

FIG. 13 illustrates a cross-sectional view of a dispense interface with a y-channel.

### DETAILED DESCRIPTION

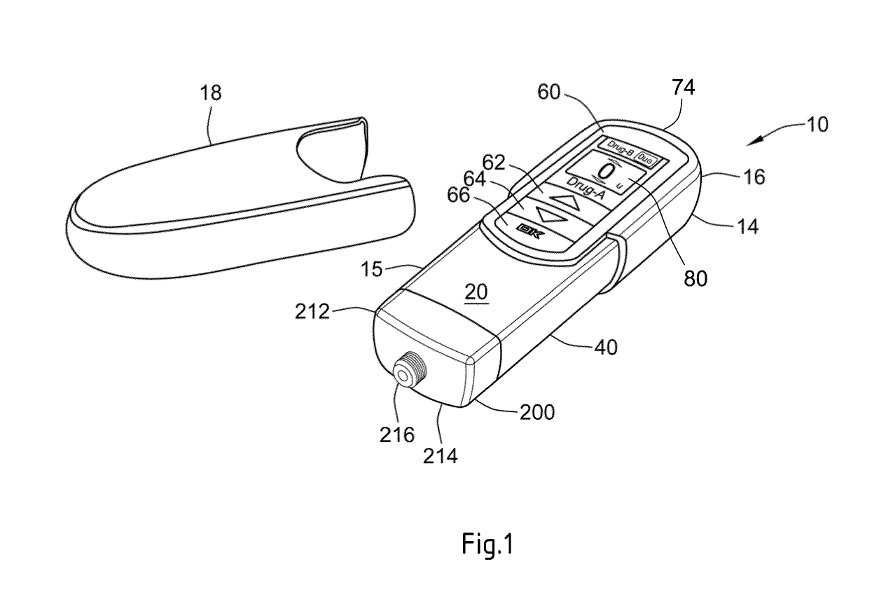

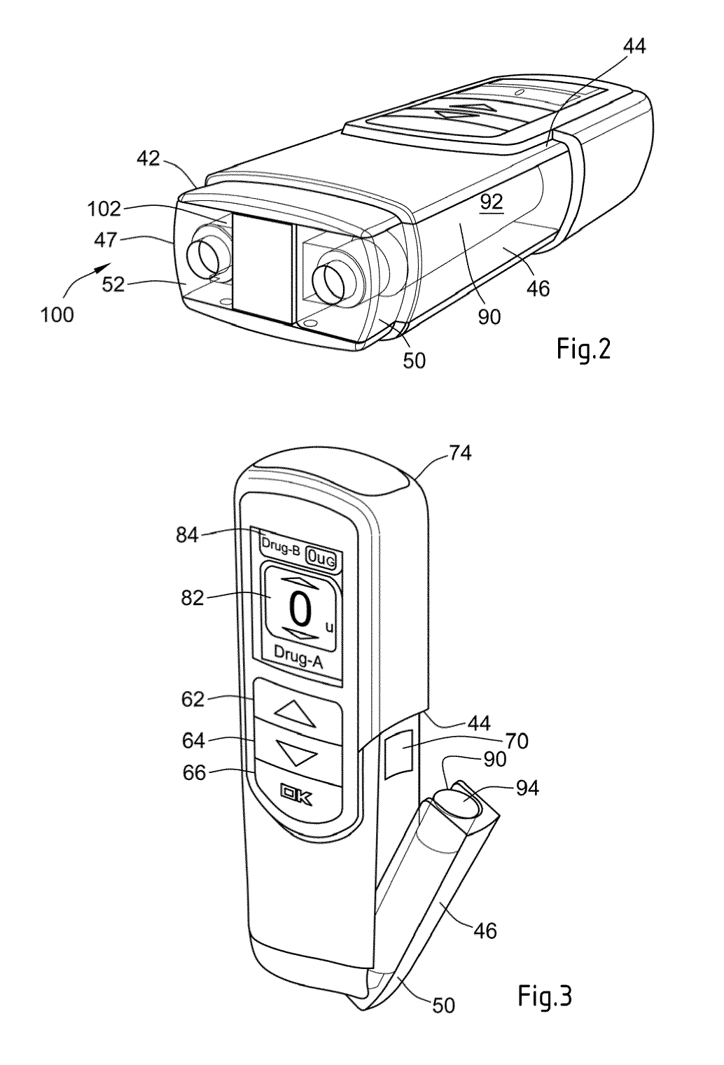

The drug delivery device illustrated in FIG. 1 comprises a main body 14 that extends from a proximal end 16 to a distal end 15. At the distal end 15, a removable end cap or cover 18 is provided. This end cap 18 and the distal end 15 of the main body 14 work together to provide a snap fit or form fit connection so that once the cover 18 is slid onto the distal end 15 of the main body 14, this frictional fit between the cap and the main body outer surface 20 prevents the cover from inadvertently falling off the main body.

The main body 14 contains a micro-processor control unit, an electro-mechanical drive train, and at least two medicament reservoirs. When the end cap or cover 18 is removed from the device 10 (as illustrated in FIG. 1), a dispense interface 200 is mounted to the distal end 15 of the main body 14, and a dose dispenser (e.g., a needle assembly) is attached to the interface. The drug delivery device 10 can be used to administer a computed dose of a second medicament (secondary drug compound) and a variable dose of a first medicament (primary drug compound) through a single needle assembly, such as a double ended needle assembly.

A control panel region 60 is provided near the proximal end of the main body 14. Preferably, this control panel region 60 comprises a digital display 80 along with a plurality of human interface elements that can be manipulated by a user to set and inject a combined dose. In this arrangement, the control panel region comprises a first dose setting button 62, a second dose setting button 64 and a third button 66 designated with the symbol “OK.” In addition, along the most proximal end of the main body, an injection button 74 is also provided (not visible in the perspective view of FIG. 1).

The cartridge holder 40 can be removably attached to the main body 14 and may contain at least two cartridge retainers 50 and 52. Each retainer is configured so as to contain one medicament reservoir, such as a glass cartridge. Preferably, each cartridge contains a different medicament.

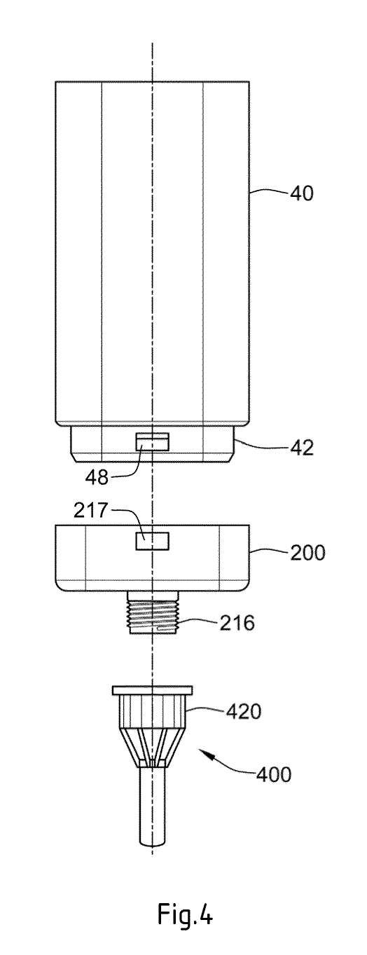

In addition, at the distal end of the cartridge holder 40, the drug delivery device illustrated in FIG. 1 includes a dispense interface 200. As will be described in relation to FIG. 4, in one arrangement, this dispense interface 200 includes a main outer body 212 that is removably attached to a distal end 42 of the cartridge housing 40. As can be seen in FIG. 1, a distal end 214 of the dispense interface 200 preferably comprises a needle hub 216. This needle hub 216 may be configured so as to allow a dose dispenser, such as a conventional pen type injection needle assembly, to be removably mounted to the drug delivery device 10.

Once the device is turned on, the digital display 80 shown in FIG. 1 illuminates and provides the user certain device information, preferably information relating to the medicaments contained within the cartridge holder 40. For example, the user is provided with certain information relating to both the primary medicament (Drug A) and the secondary medicament (Drug B).

As shown in FIG. 3, the first and a second cartridge retainers 50, 52 comprise hinged cartridge retainers. These hinged retainers allow user access to the cartridges. FIG. 3 illustrates a perspective view of the cartridge holder 40 illustrated in FIG. 1 with the first hinged cartridge retainer 50 in an open position. FIG. 3 illustrates how a user might access the first cartridge 90 by opening up the first retainer 50 and thereby having access to the first cartridge 90.

As mentioned above when discussing FIG. 1, a dispense interface 200 is coupled to the distal end of the cartridge holder 40. FIG. 4 illustrates a flat view of the dispense interface 200 unconnected to the distal end of the cartridge holder 40. A dose dispenser or needle assembly that may be used with the interface 200 is also illustrated and is provided in a protective outer cap 420.

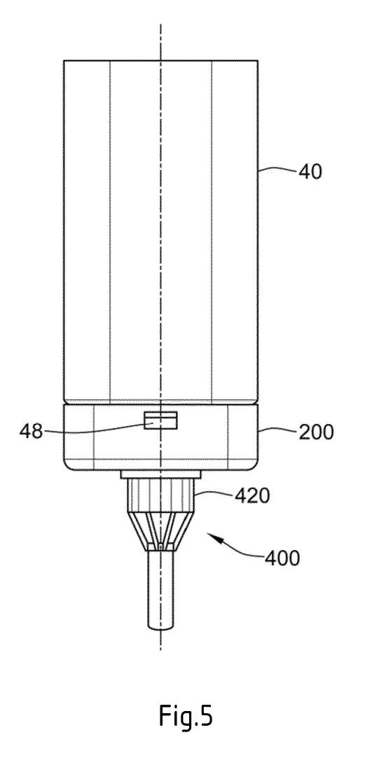

In FIG. 5, the dispense interface 200 illustrated in FIG. 4 is shown coupled to the cartridge holder 40. The axial attachment means between the dispense interface 200 and the cartridge holder 40 can be any known axial attachment means to those skilled in the art, including snap locks, snap fits, snap rings, keyed slots, and combinations of such connections. The connection or attachment between the dispense interface and the cartridge holder may also contain additional features (not shown), such as connectors, stops, splines, ribs, grooves, pips, clips and the like design features, that ensure that specific hubs are attachable only to matching drug delivery devices. Such additional features would prevent the insertion of a non-appropriate secondary cartridge to a non-matching injection device.

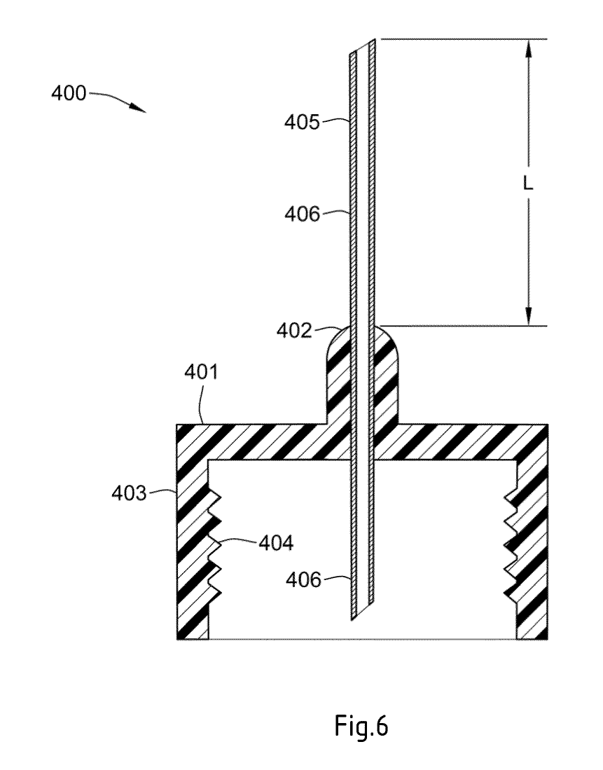

FIG. 5 also illustrates the needle assembly 400 and protective cover 420 coupled to the distal end of the dispense interface 200 that may be screwed onto the needle hub of the interface 200. FIG. 6 illustrates a cross sectional view of the double ended needle assembly 402 mounted on the dispense interface 200 in FIG. 5.

The needle assembly 400 illustrated in FIG. 6 comprises a double ended needle 406 and a hub 401. The double ended needle or cannula 406 is fixedly mounted in a needle hub 401. This needle hub 401 comprises a circular disk shaped element which has along its periphery a circumferential depending sleeve 403. Along an inner wall of this hub member 401, a thread 404 is provided. This thread 404 allows the needle hub 401 to be screwed onto the dispense interface 200 which, in one preferred arrangement, is provided with a corresponding outer thread along a distal hub. At a center portion of the hub element 401 there is provided a protrusion 402. This protrusion 402 projects from the hub in an opposite direction of the sleeve member. A double ended needle 406 is mounted centrally through the protrusion 402 and the needle hub 401. This double ended needle 406 is mounted such that a first or distal piercing end 405 of the double ended needle forms an injecting part for piercing an injection site (e.g., the skin of a user).

Similarly, a second or proximal piercing end 406 of the needle assembly 400 protrudes from an opposite side of the circular disc so that it is concentrically surrounded by the sleeve 403. In one needle assembly arrangement, the second or proximal piercing end 406 may be shorter than the sleeve 403 so that this sleeve to some extent protects the pointed end of the back sleeve. The needle cover cap 420 illustrated in FIGS. 4 and 5 provides a form fit around the outer surface 403 of the hub 401.

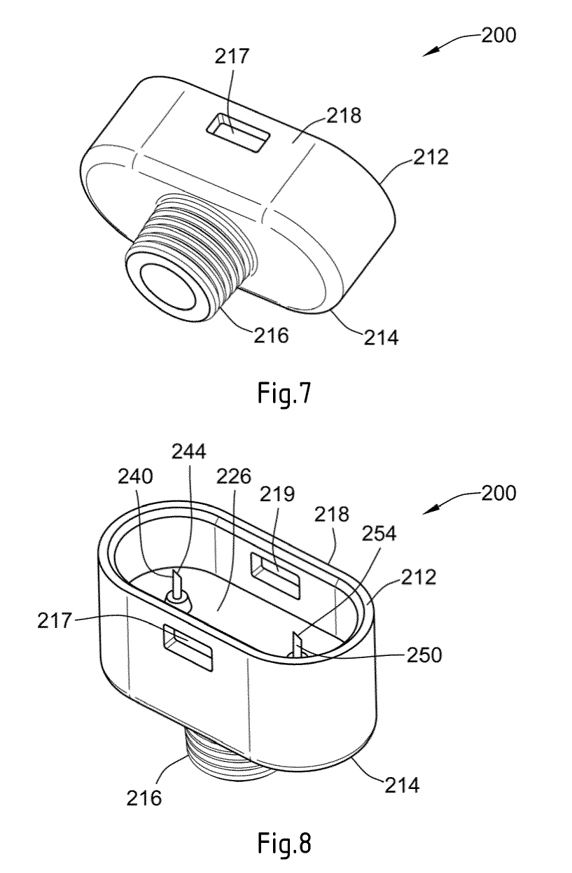

Referring now to FIGS. 4 to 11, one preferred arrangement of this interface 200 will now be discussed. In this one preferred arrangement, this interface 200 comprises:

a. a main outer body 210,

b. an first inner body 220,

c. a second inner body 230,

d. a first piercing needle 240,

e. a second piercing needle 250,

f. a valve seal 260, and

g. a septum 270.

The main outer body 210 comprises a main body proximal end 212 and a main body distal end 214. At the proximal end 212 of the outer body 210, a connecting member is configured so as to allow the dispense interface 200 to be attached to the distal end of the cartridge holder 40. Preferably, the connecting member is configured so as to allow the dispense interface 200 to be removably connected the cartridge holder 40. In one preferred interface arrangement, the proximal end of the interface 200 is configured with an upwardly extending wall 218 having at least one recess. For example, as may be seen from FIG. 8, the upwardly extending wall 218 comprises at least a first recess 217 and a second recess 219.

Preferably, the first and the second recesses 217, 219 are positioned within this main outer body wall so as to cooperate with an outwardly protruding member located near the distal end of the cartridge housing 40 of the drug delivery device 10. For example, this outwardly protruding member 48 of the cartridge housing may be seen in FIGS. 4 and 5. A second similar protruding member is provided on the opposite side of the cartridge housing. As such, when the interface 200 is axially slid over the distal end of the cartridge housing 40, the outwardly protruding members will cooperate with the first and second recess 217, 219 to form an interference fit, form fit, or snap lock. Alternatively, and as those of skill in the art will recognize, any other similar connection mechanism that allows for the dispense interface and the cartridge housing 40 to be axially coupled could be used as well.

The main outer body 210 and the distal end of the cartridge holder 40 act to form an axially engaging snap lock or snap fit arrangement that could be axially slid onto the distal end of the cartridge housing. In one alternative arrangement, the dispense interface 200 may be provided with a coding feature so as to prevent inadvertent dispense interface cross use. That is, the inner body of the hub could be geometrically configured so as to prevent an inadvertent cross use of one or more dispense interfaces.

A mounting hub is provided at a distal end of the main outer body 210 of the dispense interface 200. Such a mounting hub can be configured to be releasably connected to a needle assembly. As just one example, this connecting means 216 may comprise an outer thread that engages an inner thread provided along an inner wall surface of a needle hub of a needle assembly, such as the needle assembly 400 illustrated in FIG. 6. Alternative releasable connectors may also be provided such as a snap lock, a snap lock released through threads, a bayonet lock, a form fit, or other similar connection arrangements.

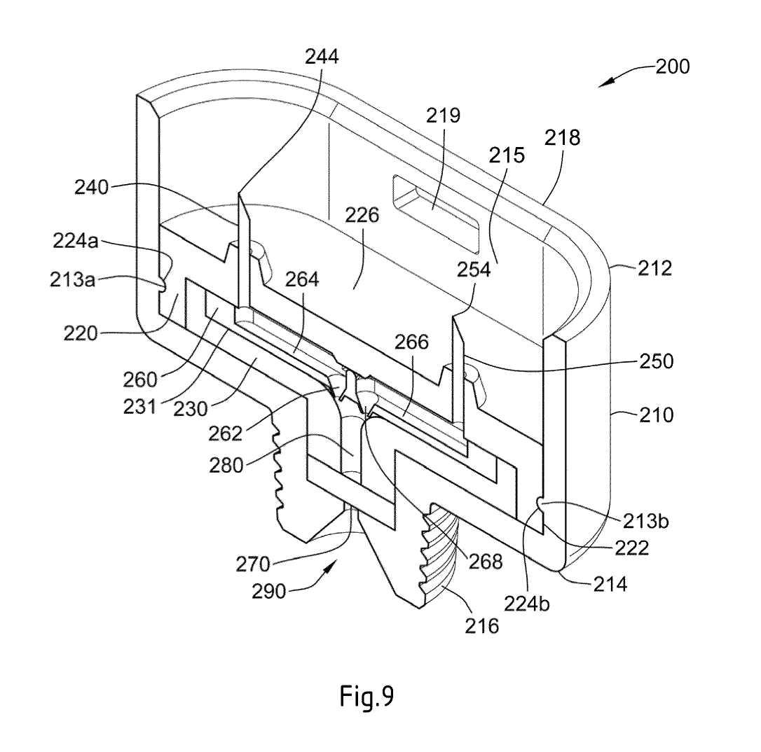

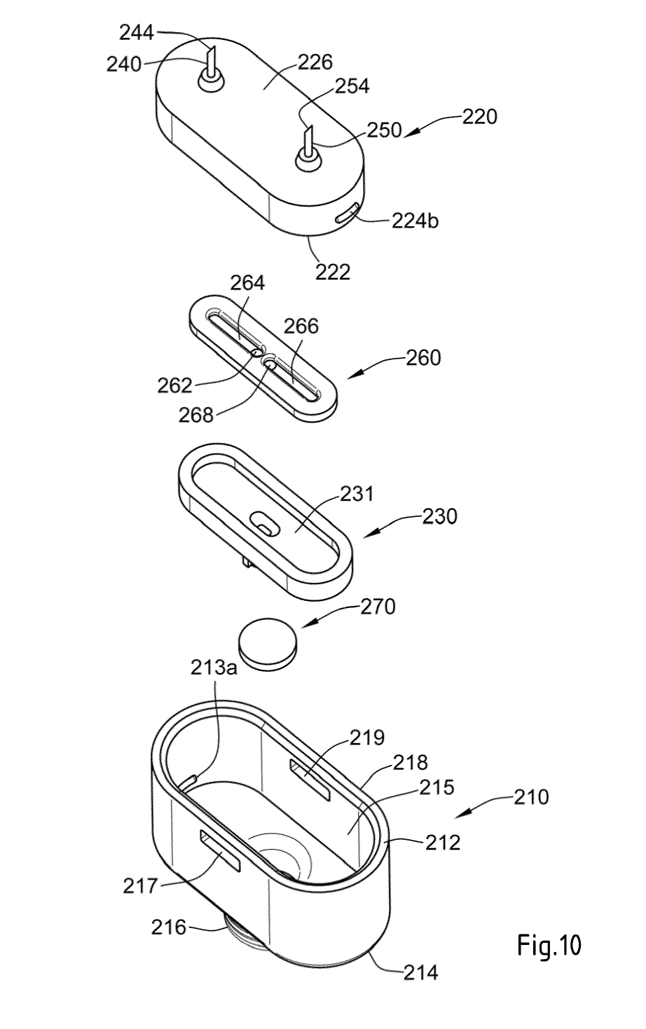

The dispense interface 200 further comprises a first inner body 220. Certain details of this inner body are illustrated in FIG. 8-11. Preferably, this first inner body 220 is coupled to an inner surface 215 of the extending wall 218 of the main outer body 210. More preferably, this first inner body 220 is coupled by way of a rib and groove form fit arrangement to an inner surface of the outer body 210. For example, as can be seen from FIG. 9, the extending wall 218 of the main outer body 210 is provided with a first rib 213a and a second rib 213b. This first rib 213a is also illustrated in FIG. 10. These ribs 213a and 213b are positioned along the inner surface 215 of the wall 218 of the outer body 210 and create a form fit or snap lock engagement with cooperating grooves 224a and 224b of the first inner body 220. In a preferred arrangement, these cooperating grooves 224a and 224b are provided along an outer surface 222 of the first inner body 220.

In addition, as can be seen in FIG. 8-10, a proximal surface 226 near the proximal end of the first inner body 220 may be configured with at least a first proximally positioned piercing needle 240 comprising a proximal piercing end portion 244. Similarly, the first inner body 220 is configured with a second proximally positioned piercing needle 250 comprising a proximally piercing end portion 254. Both the first and second needles 240, 250 are rigidly mounted on the proximal surface 226 of the first inner body 220.

Preferably, this dispense interface 200 further comprises a valve arrangement. Such a valve arrangement could be constructed so as to prevent cross contamination of the first and second medicaments contained in the first and second reservoirs, respectively. A preferred valve arrangement may also be configured so as to prevent back flow and cross contamination of the first and second medicaments.

In one preferred system, dispense interface 200 includes a valve arrangement in the form of a valve seal 260. Such a valve seal 260 may be provided within a cavity 231 defined by the second inner body 230, so as to form a holding chamber 280. Preferably, cavity 231 resides along an upper surface of the second inner body 230. This valve seal comprises an upper surface that defines both a first fluid groove 264 and second fluid groove 266. For example, FIG. 9 illustrates the position of the valve seal 260, seated between the first inner body 220 and the second inner body 230. During an injection step, this seal valve 260 helps to prevent the primary medicament in the first pathway from migrating to the secondary medicament in the second pathway, while also preventing the secondary medicament in the second pathway from migrating to the primary medicament in the first pathway. Preferably, this seal valve 260 comprises a first non-return valve 262 and a second non-return valve 268. As such, the first non-return valve 262 prevents fluid transferring along the first fluid pathway 264, for example a groove in the seal valve 260, from returning back into this pathway 264. Similarly, the second non-return valve 268 prevents fluid transferring along the second fluid pathway 266 from returning back into this pathway 266.

Together, the first and second grooves 264, 266 converge towards the non-return valves 262 and 268 respectively, to then provide for an output fluid path or a holding chamber 280. This holding chamber 280 is defined by an inner chamber defined by a distal end of the second inner body both the first and the second non return valves 262, 268 along with a pierceable septum 270. As illustrated, this pierceable septum 270 is positioned between a distal end portion of the second inner body 230 and an inner surface defined by the needle hub of the main outer body 210.

The holding chamber 280 terminates at an outlet port of the interface 200. This outlet port 290 is preferably centrally located in the needle hub of the interface 200 and assists in maintaining the pierceable seal 270 in a stationary position. As such, when a double ended needle assembly is attached to the needle hub of the interface (such as the double ended needle illustrated in FIG. 6), the output fluid path allows both medicaments to be in fluid communication with the attached needle assembly.

The hub interface 200 further comprises a second inner body 230. As can be seen from FIG. 9, this second inner body 230 has an upper surface that defines a recess, and the valve seal 260 is positioned within this recess. Therefore, when the interface 200 is assembled as shown in FIG. 9, the second inner body 230 will be positioned between a distal end of the outer body 210 and the first inner body 220. Together, second inner body 230 and the main outer body hold the septum 270 in place. The distal end of the inner body 230 may also form a cavity or holding chamber that can be configured to be fluid communication with both the first groove 264 and the second groove 266 of the valve seal.

Axially sliding the main outer body 210 over the distal end of the drug delivery device attaches the dispense interface 200 to the multi-use device. In this manner, a fluid communication may be created between the first needle 240 and the second needle 250 with the primary medicament of the first cartridge and the secondary medicament of the second cartridge, respectively.

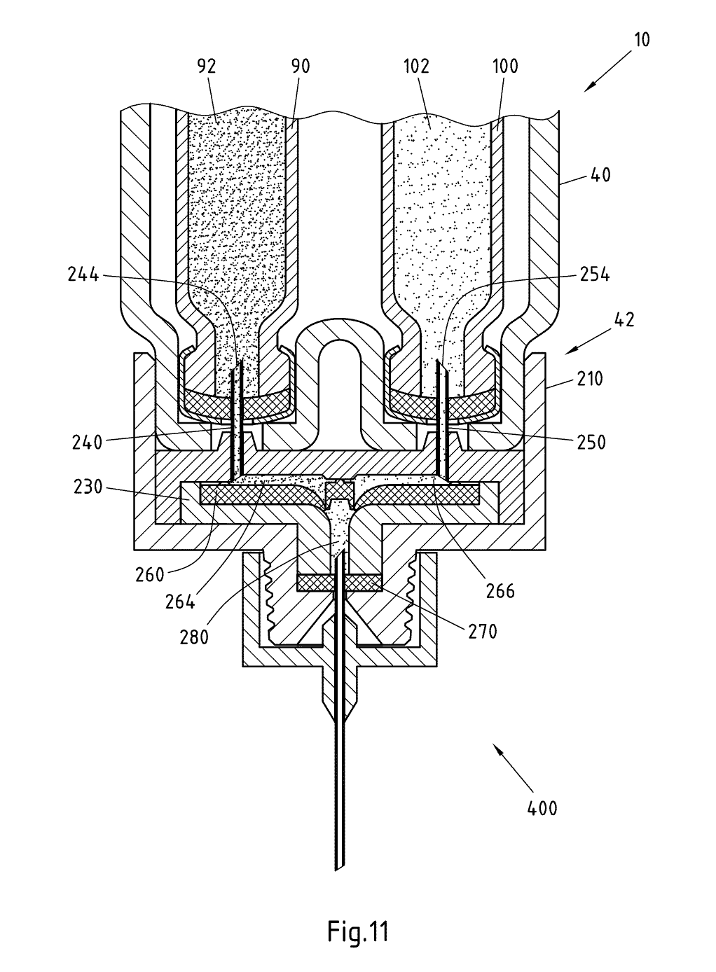

FIG. 11 illustrates the dispense interface 200 after it has been mounted onto the distal end 42 of the cartridge holder 40 of the drug delivery device 10 illustrated in FIG. 1. A double ended needle 400 is also mounted to the distal end of this interface. The cartridge holder 40 is illustrated as having a first cartridge containing a first medicament and a second cartridge containing a second medicament.

When the interface 200 is first mounted over the distal end of the cartridge holder 40, the proximal piercing end 244 of the first piercing needle 240 pierces the septum of the first cartridge 90 and thereby resides in fluid communication with the primary medicament 92 of the first cartridge 90. A distal end of the first piercing needle 240 will also be in fluid communication with a first fluid path groove 264 defined by the valve seal 260.

Similarly, the proximal piercing end 254 of the second piercing needle 250 pierces the septum of the second cartridge 100 and thereby resides in fluid communication with the secondary medicament 102 of the second cartridge 100. A distal end of this second piercing needle 250 will also be in fluid communication with a second fluid path groove 266 defined by the valve seal 260.

FIG. 11 illustrates a preferred arrangement of such a dispense interface 200 that is coupled to a distal end 15 of the main body 14 of drug delivery device 10. Preferably, such a dispense interface 200 is removably coupled to the cartridge holder 40 of the drug delivery device 10.

As illustrated in FIG. 11, the dispense interface 200 is coupled to the distal end of a cartridge housing 40. This cartridge holder 40 is illustrated as containing the first cartridge 90 containing the primary medicament 92 and the second cartridge 100 containing the secondary medicament 102. Once coupled to the cartridge housing 40, the dispense interface 200 essentially provides a mechanism for providing a fluid communication path from the first and second cartridges 90, 100 to the common holding chamber 280. This holding chamber 280 is illustrated as being in fluid communication with a dose dispenser. Here, as illustrated, this dose dispenser comprises the double ended needle assembly 400. As illustrated, the proximal end of the double ended needle assembly is in fluid communication with the chamber 280.

In one preferred arrangement, the dispense interface is configured so that it attaches to the main body in only one orientation, that is it is fitted only one way round. As such as illustrated in FIG. 11, once the dispense interface 200 is attached to the cartridge holder 40, the primary needle 240 can only be used for fluid communication with the primary medicament 92 of the first cartridge 90 and the interface 200 would be prevented from being reattached to the holder 40 so that the primary needle 240 could now be used for fluid communication with the secondary medicament 102 of the second cartridge 100. Such a one way around connecting mechanism may help to reduce potential cross contamination between the two medicaments 92 and 102.

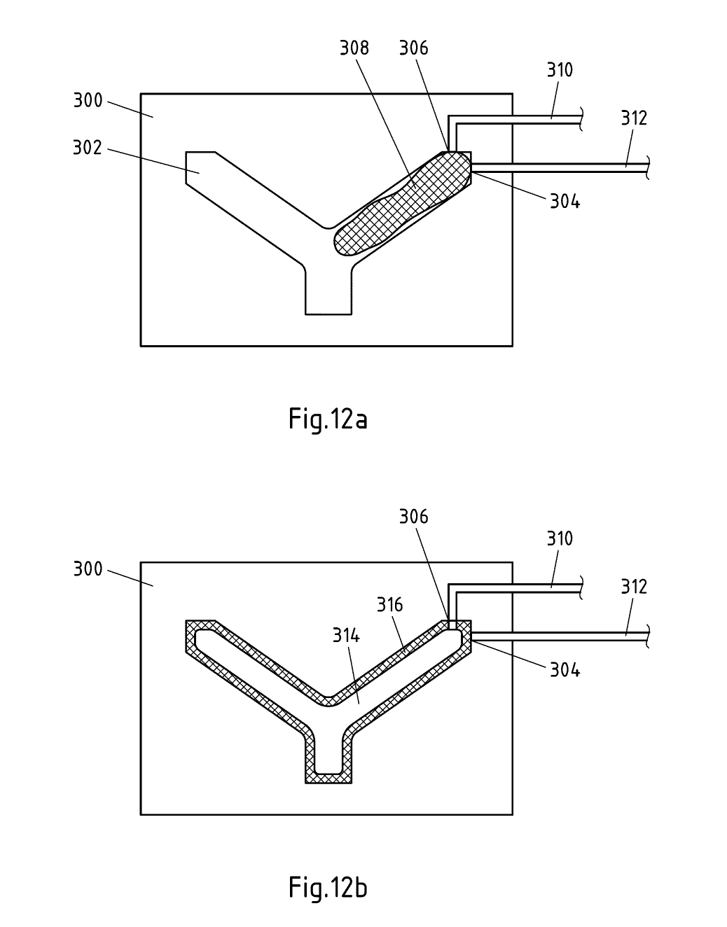

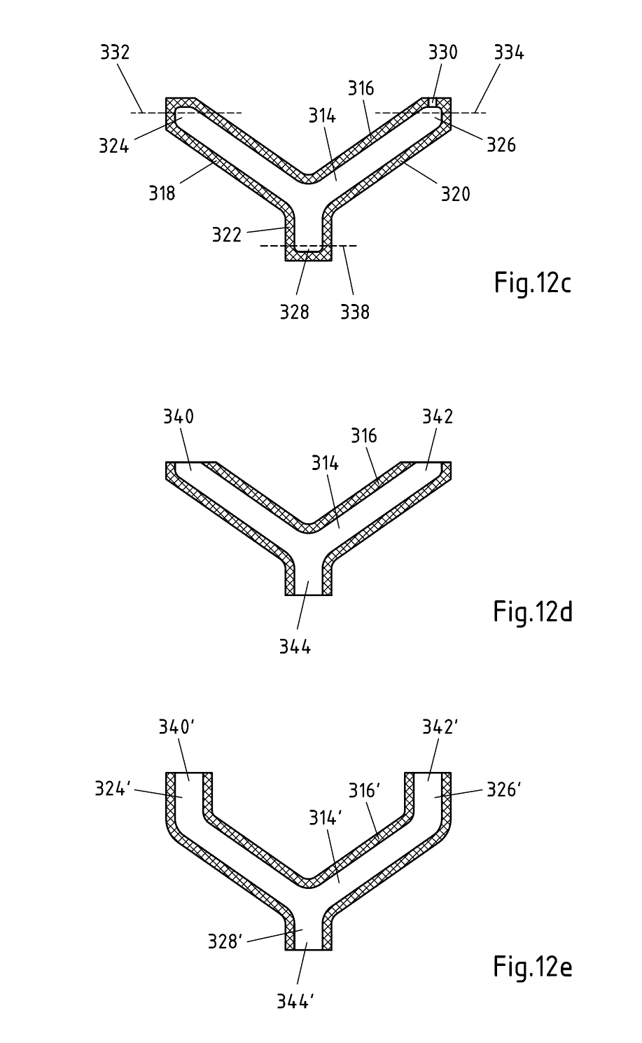

FIG. 12a-d illustrate the production of a y-channel with GIT/WIT. It will only be described with respect to GIT, but the description can be used for WIT in an analogue manner.

Turning first to FIG. 12a, one can see a device 300 comprising a mold 302, and an injection site 304 for molten plastic and a second injection site 306 for gas. In this step of the production, molten plastic 308 is inserted via a first guide 312 into the mold 302. The outer part of the molten plastic 308 starts to cool down while the inner part is being kept hot. Right before or right after the end of the molten plastic injection process, the gas injection via the guide 310 can start. The gas is preferably an inert gas, for example nitrogen.

As illustrated in FIG. 12b, a y-channel 314 is formed within the molten plastic 308, which is pushed to the walls of the mold 302 and solidifies as a plastic part 316. After the plastic part 316 has cooled down, it can be taken out of the mold 302.

The produced plastic part 316 with the y-channel 314 as illustrated in FIG. 12c has a first arm 318, a second arm 320 and a third arm 322. These three arms 318, 320, 322 each have an end 324, 326 and 328, respectively. The two arms 318, 320 form an angle which is smaller than 180°. The third arm 322 extends away from said angle. The second arm 320 has at its end 326 an opening 330 due to the gas injection guide 310. Along the lines 332, 334, 338 the ends 324, 326, 328 are cut off from the plastic part 316. By this step all three ends 324, 326, 328 are opened. This cutting is preferably done with mechanical means, but it can also be done by laser cutting, for example.

As can be seen in FIG. 12d the three arms 318, 320, 322 of the plastic part 316 with the y-channel 314 have now defined openings 340, 342 and 344, respectively. Through the openings 340 and 342 preferably two different medicaments 92, 102 can enter the y-channel 314 and through the opening 344 a mixture of the two medicaments 92, 102 can exit the y-channel 314.

FIG. 12e shows another exemplary embodiment of an apparatus according to the invention. Similar to the plastic part 316 shown in FIG. 12d, the plastic part 316′ shown in FIG. 12e has three ends 324′, 326′, 328′, which have the openings 340′, 342′ and 344′, respectively. The plastic part 316′ can be produced in the same way as the plastic part 316. In contrast to the plastic pat 316 shown in FIG. 12e, the ends 340′ and 342′ extend substantially parallel to each other. In this case they also extend parallel to the third end 328′, such that if the axis of the third end 328′ defines a downward direction, the first end 324′ and second end 326′ extend substantially in the upward direction. This further facilitates the manufacturing process. Moreover, this further facilitates the insertion of needles into the ends 324′ and 326′.

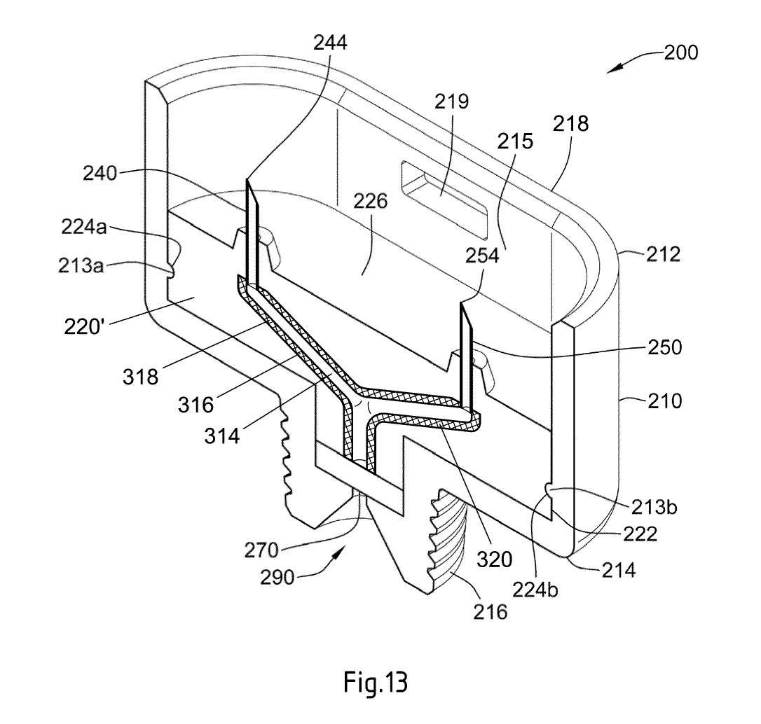

FIG. 13 illustrates a cross-sectional view of a dispense interface 200 similar to the one illustrated in FIG. 9. The dispense interface 200 illustrated in FIG. 13 shows the plastic part 316 and the y-channel 314 illustrated in FIG. 12d. The plastic part 316 is integrated via form fit into a first inner body 220′. Together with a second half of the inner body (not illustrated) the plastic part 316 can be fixed in between the inner bodies, for example. The inner body 220′ can then be attached to the main outer body 210 in the already described manner.

The piercing needle 240 is attached to the opening 340 of the first arm 318 of the y-channel 314. Accordingly the piercing needle 250 is attached to the opening 342 of the second arm 320 of the y-channel 314. The attachment of the needles 240, 250 to the y-channel 314 can be realised by any appropriate method, for example form fit or force fit connections, or by adhesive bonding. The third opening 344 of the y-channel 314 is sealed by a pierceable septum 270. Those features shown in FIG. 13, which are also shown in FIG. 9, are further described in connection with the description of FIG. 9.

1-13. (canceled)

14. An apparatus, comprising:
a plastic part and
a channel within said plastic part configured to guide at least one fluid,
wherein said channel is configured to be used in a medical device,
wherein said channel is a y-channel having three ends and
wherein said channel is produced with gas injection technique and/or water injection technique.

15. Apparatus according to claim 14, wherein said plastic part substantially has the form of said y-channel.

16. Apparatus according to claim 1, wherein said y-channel has an opening at all three ends.

17. Apparatus according to claim 14, wherein at least one of said openings is produced by cutting said y-channel.

18. Apparatus according to claim 14, wherein said y-channel has a substantially constant diameter.

19. Apparatus according to claim 14, wherein said y-channel has a diameter between 0.08 and 3 mm.

20. Apparatus according to claim 14, said apparatus further comprises an inner body and/or a main outer body.

21. Apparatus according to claim 14, wherein said apparatus is a dispense interface.

22. A Method to produce at least a part of a medical device, comprising the steps of
producing a y-channel within a plastic part with gas injection technique and/or water injection technique and
opening said y-channel to produce at least one opening.

23. Method according claim 23, wherein all three ends of said y-channel are opened.

24. Method according to claim 22, wherein said plastic part is further implemented into an inner body.

25. Method according to claim 22, wherein said plastic part is further implemented into a main outer body of a dispense interface.

26. Method according to claim 22, wherein said y-channel has a diameter between 0.08 and 3 mm.
